(19) United States
(12) Patent Application Publication
(10) Pub. No.: US 2007/0014325 A1
(43) Pub. Date: Jan. 18, 2007

(54) Optically pumped semiconductor laser

(75) Inventors: Byeong-Hoon Park, Yongin-si (KR); Sun-Lyeong Hwang, Suwon-si (KR); Sung-Soo Park, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/400,257

(22) Filed: Apr. 7, 2006

(30) Foreign Application Priority Data
Jul. 13, 2005 (KR) 2005-63451

(51) Int. Cl. H01S 3/10; H01S 3/04; H01S 3/091; H01S 3/08; H01S 3/092

(52) U.S. Cl. 372/70; 372/21; 372/99; 372/36

(57) ABSTRACT

An optically pumped semiconductor laser and an optical pumping method are disclosed. The optically pumped semiconductor laser includes first and second reflective bodies forming a resonant region therebetween, a gain medium disposed between the first and second reflective bodies; and a light source for applying a source light to the resonant region in a lateral direction with regard to the gain medium for generating a basic wavelength. The laser further comprising an output mirror and a nonlinear crystal disposed between the output mirror and the second reflective body to generate a predetermined wavelength as a second harmonic of the basic wavelength.

### CLAIM OF PRIORITY

This application claims the benefit of the earlier filing date, pursuant to 35 U.S.C. §119, of that patent application filed Jul. 13, 2005 in the Korean Patent Office and afforded Patent Application Serial No. 2005-0063451, the disclosure of which is incorporated by reference in its entirety, herein.

### BACKGROUND OF THE INVENTION

1. Field of the Invention

The present invention relates to a semiconductor laser and, more particularly, to an optically pumped semiconductor laser.

2. Description of Related Art

After the invention of a semiconductor laser, laser technology has been significantly developed with the commercialization of a long-wavelength optical communication laser (1310 nm, 1490 nm, 1550 nm) using an InP substrate and shorter wavelength laser (780 nm, 650 nm) using a GaAs substrate typically used as a CD and DVD pick-up.

In addition, blue-ray disc technology has been developed using a jade green laser (405 nm) on an Al₂O₃ substrate with a GaN active layer. Conventionally, three primary colors R (red), G (green) and B (blue) in the visible light region (approximately 380 nm to 760 nm) can be used as a light source for a display device having good color reproduction characteristics. Ideally, the wavelengths are selected to be substantially equal to 635 nm, 532 nm, and 455 nm, respectively.

In current semiconductor laser technology, a laser operating at a red light(635 nm) can be fabricated by growing an AlGaInP active layer on a GaAs substrate. Similarly a laser operating at a green light(532 nm) or a blue light(455 nm) can be fabricated through a second harmonic generation (SHG) process, wherein an infrared laser light of 1064 nm or 910 nm is passed through a nonlinear crystal. The infrared laser light can be generated obtained using a solid laser pumping process. The blue light (445 nm) may be fabricated by applying an InGaN active layer to a GaN substrate.

Recently, a vertical extended cavity surface-emitting laser (VECSEL) having high efficiency is attracting attention as a new technology. The VECSEL laser includes a semiconductor epitaxy structure having a distributed Bragg reflector mirror (DBR), an active layer, such as a quantum well, a cladding window, and a resonator with an output mirror. The nonlinear crystal is inserted into the resonator to obtain intracavity-type second harmonic generation.

The VECSEL is classified as an optically pumped semiconductor laser (OPSL) for exciting semiconductor epitaxy through optical pumping, and a Novalux VECSEL (NECSEL) employing an electric injection type.

A conventional OPSL is disclosed in U.S. Pat. No. 5,991,318, entitled “Intracavity Frequency-Converted Optically Pumped Semiconductor Laser”. The optical pumping method described in the '318 patent introduces pumped light at an angle inclined to a surface. In this case, the optically pumped light is directly absorbed through a cladding window.

While the method of '318 patent can obtain a high output of second harmonic generation using a focusing lens and a nonlinear crystal, it is impossible to reduce a distance between a pumping light source and epitaxy structure as the focusing lens blocks infrared light as the pumping light source comes close to the epitaxy structure. Therefore, the method of '318 patent is capable of generating a high output of laser, but it is difficult to miniaturize the system.

### SUMMARY OF THE INVENTION

One aspect of the present invention is to provide an optically pumped semiconductor laser and an optical pumping method capable of miniaturizing the structure of the optically pumped semiconductor laser.

Another aspect of the present invention is to provide an ultra small blue or green semiconductor laser and an optical pumping method using a side pumping method having low threshold pumping power, epitaxy structure, easy packaging and excellent thermal characteristics.

An optically pumped semiconductor laser in accordance with one aspect of the present invention includes first and second reflective bodies for forming a resonant region, a gain medium disposed between the first and second reflective bodies and a light source for applying source light to the resonant region in a lateral direction with regard to the gain medium for generating a basic wavelength.

The gain medium may include a plurality of quantum wells.

A basic wavelength generated by resonance in the resonant region may be applied to the second reflective body, and an output mirror for emitting a predetermined wavelength as a second harmonic of the basic wavelength generated by a nonlinear crystal disposed between the output mirror and the second reflective body.

The semiconductor laser may further include a nonlinear crystal disposed between the output mirror and the second reflective body to generate a second harmonic having a predetermined wavelength of the basic wavelength generated in the gain medium.

A selective reflective part may be disposed at a surface of the output mirror opposite to the nonlinear crystal to transmit the predetermined wavelength and to reflect the basic wavelength.

A filter may be disposed between the second reflective body and the nonlinear crystal to maintain uniform polarization of the basic wavelength and to transmit the basic wavelength to the gain medium.

A heat sink may be disposed between the filter and the first reflective body.

The heat sink may be formed of one of silicon carbide (SiC) and titatium carbide (TiC).

In one aspect of the invention, the source light may have a wavelength of 808 nm, the basic wavelength may be one of 910 nm or 1064 nm, and the predetermined wavelength may be one of 455 nm or 532 nm.

A substrate may be installed at a surface of the first reflective body opposite to a surface of the first reflective body in contact with the gain medium, and the source light may be applied to the substrate in a lateral direction.

The first reflective body may be formed of a multi-layered semiconductor material, and have at least one dielectric layer formed at a surface opposite to the substrate.

The surface of the substrate to which the source light is applied may be formed as a guide surface inclined to guide the source light to the gain medium.

The substrate may be formed of one of silicon carbide (SiC), aluminum nitride (AlN), or gallium arsenide (GaAs).

The inclined guide surface of the substrate may have a source light reflective part for reflecting the source light to the gain medium.

A groove may be formed on a surface of the substrate opposite to a surface of the substrate in contact with the gain medium.

An optically pumped semiconductor laser in accordance with another aspect of the present invention includes a substrate, an output mirror installed apart from the substrate to form a resonant region between the substrate and the output mirror, a light source for applying source light to the substrate in a lateral direction, a guide part for guiding the source light applyed to the substrate toward the output mirror, a gain medium disposed between the substrate and the output mirror to generate a basic wavelength from the source light guided by the guide part, a nonlinear crystal disposed between the gain medium and the output mirror to generate a predetermined wavelength of second harmonic of the basic wavelength, a filter disposed between the nonlinear crystal and the gain medium to transmit the basic wavelength generated from the gain medium and to reflect the second harmonic generated from the nonlinear crystal, a first reflective body disposed between the gain medium and the substrate to transmit the source light to the gain medium and to reflect the basic wavelength, a second reflective body disposed between the filter and the gain medium to reflect the source light back to the gain medium and to transmit the basic wavelength to the filter and a selective reflective part disposed at a surface of the output mirror opposite to the nonlinear crystal to transmit the predetermined wavelength and to reflect the basic wavelength.

The guide part may include an inclined surface formed at a surface of the substrate to which the source light is applied, and a source light reflective part for reflecting the source light to the gain medium.

The gain medium may be formed of a plurality of quantum wells.

The first reflective body may include at least one semiconductor material, and at least one dielectric layer formed at a surface of the first relfective body opposite to the substrate.

For example, the source light may have a wavelength of 808 nm, the basic wavelength may be one of 910 nm or 1064 nm, and the predetermined wavelength may be one of 455 nm or 532 nm.

A heat sink may be disposed between the filter and the second reflective body. The heat sink may be formed of one of silicon carbide (SiC) or titatium carbide (TiC) and The substrate may be formed of one of silicon carbide (SiC), aluminum nitride (AlN), or gallium arsenide (GaAs).

A groove may be formed on a surface of the substrate opposite to a surface of the substrate in contact with the gain medium.

An optical pumping method of a semiconductor laser in accordance with yet another aspect of the present invention includes applying a source light in a direction substantially perpendicular to a resonant direction, reflecting the source light toward the gain medium to generate a basic wavelength through the gain medium and generating a second harmonic by passing the basic wavelength generated from the gain medium through a nonlinear crystal and outputting the second harmonic.

The source light may be applied in a direction approximately perpendicular to an output direction of the oscillating laser.

The source light may be applied to the substrate disposed at one side of the gain medium, and the substrate may have a groove.

### BRIEF DESCRIPTION OF THE DRAWINGS

FIG. 1 is a schematic view of an optically pumped semiconductor laser in accordance with an exemplary embodiment of the present invention.

FIG. 2 is a graph showing reflectance of a reflective body versus a wavelength of 1064 nm in an optically pumped semiconductor laser in accordance with an exemplary embodiment of the present invention.

FIG. 3 is a graph showing reflectance versus wavelength when a dielectric layer is formed on a distributed Bragg reflector mirror of an optically pumped semiconductor laser in accordance with an exemplary embodiment of the present invention.

FIG. 4 is a side view of a substrate of an optically pumped semiconductor laser in accordance with another exemplary embodiment of the present invention.

FIG. 5 is a side view of a substrate of an optically pumped semiconductor laser in accordance with still another exemplary embodiment of the present invention.

FIG. 6 is a flow chart illustrating an optical pumping method in accordance with an exemplary embodiment of the present invention.

### DETAILED DESCRPTION OF THE INVENTION

Hereinafter, the detailed description of an exemplary embodiment in accordance with the present invention will be apparent in connection with the accompanying drawings.

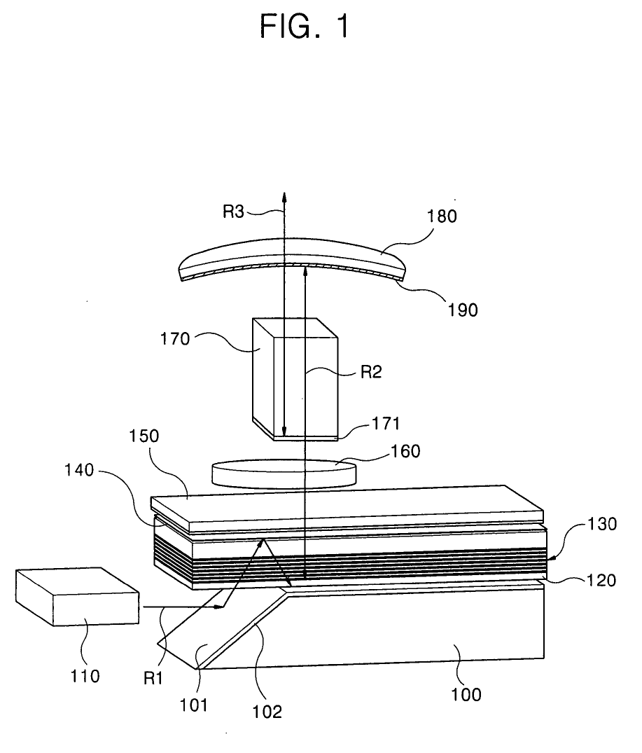

As shown in FIG. 1, a semiconductor laser includes a substrate 100. The substrate 100 may be formed of silicon carbide (SiC), for example. However, the substrate 100 of another exemplary embodiment may be formed of aluminum nitride (AlN) or gallium arsenide (GaAs).

A light source 110 is installed outside the substrate 100. Preferably, an applied direction of the light source 110 is substantially perpendicular to a side surface of the substrate 100. The light source 110 may employ a laser diode, which generates a source light referred to as R1, herein. Light R1 emitted from the light source 110 preferably has a wavelength of 808 nm.

An inclined guide surface 101 is formed at a surface of the substrate 100, to which source light R1 is applied, that reflects the source light R1 in a direction approximately perpendicular to the applied direction. The guide surface 101 may be formed to an inclined angle of about 45°. The angle may be variously modified depending on more specific embodiments of the invention.

In an exemplary embodiment of a method of forming the guide surface 101, the guide surface 101 may be formed by mounting the substrate 100 at an angle having a slope of 45°, and abrading a portion of the substrate 100, at which the guide surface 101 is to be formed. In this case, a dry or wet etching method may be employed, for example. Furthermore, in order to obtain uniform flatness and profile of the surface 101, a separate physical or chemical polishing operation may additionally be performed.

A source light reflective part 102 is applied to the guide surface 101 to reflect the source light R1. The source light reflective part 102 may be formed of any material that can reflect the source light R1. Detailed description of the material will be omitted as various well-known materials may be applied by other reflective bodies as described below. A gain medium 130 is disposed on the substrate 100. The gain medium 130 may include a multi-layered quantum well formed by a multi-layer thin film forming process. Specifically, the gain medium 130 may include pump-absorbing regions, quantum wells for generating a basic wavelength R2, and a barrier layer for compensating strain.

The quantum well may employ a periodic resonant gain type arranged in antinodes of a standing wave formed in the semiconductor to obtain high gain.

In addition, the quantum well may include a cladding window at its upper side. The cladding window may be formed of Gallium Arsenide Phosphide (GaAsP) or Aluminum Gallium Arsenide (Al_{0.3}Ga_{0.7}As) having a large band gap to prevent optically excited carriers from recombining at its surface.

An example of the quantum well is disclosed in “Design and Characteristics of High-Power (0.5 W-CW) Diode-Pumped Vertical-External-Cavity Surface-Emitting Semiconductor Lasers with Circular TEM00 beams”, published by IEEE (Institute of Electrical and Electronics Engineers).

A first reflective body 120 is disposed between the substrate 100 and the gain medium 130. Since the gain medium 130 and the first reflective body 120 can be manufactured by a multi-layer epitaxial-growth process, they can be referred to as OPSL (optically pumped semiconductor laser epitaxy).

The first reflective body 120 may further include a distributed Bragg reflector mirror (DBR) (not shown). The DBR is formed of a multi-layered semiconductor material to selectively transmit and reflect a desired wavelength. The DBR may be manufactured by repeatedly depositing Aluminum Arsenide (AlAs) and Aluminum Gallium Arsenide (Al_{0.2}Ga_{0.8}As).

In the exemplary embodiment of the present invention, a 808 nm of source light R1, used as a pumping light, generates either a 1064 nm or 910 nm basic wavelength, referred to as R2, through the gain medium 130. In this case, the DBR in the first reflective body 120, transmits a wavelength at 808 nm (anti-reflective coating) and reflects either a 910 nm or 1064 nm (high-reflective coating) wavelength.

The DBR may be formed by depositing 30 to 40 alternate pairs of AlAs/GaAs, or if necessary Al_{0.98}Ga_{0.02}As/Al_{0.2}Ga_{0.8}As. The DBR can obtain a reflectance of more than 99.9% of the basic wavelength.

In the exemplary embodiment discussed herein, the DBR is formed by repeatedly depositing 36 pairs of AlAs and Al_{0.2}Ga_{0.8}As on a GaAs substrate 100 to transmit wavelengths at 808 nm and reflect them at 910 nm. Generally, when two dielectric layers having different refractive indexes are deposited to a thickness of λ/4n (λ=wavelength, n=the number of pairs), it is possible to obtain a high reflectance of more than 99.9% at a desired wavelength. But it is difficult to simultaneously obtain a transmissive bandwidth and a reflective bandwidth at a specific wavelength. Therefore, when the respective dielectric layers have a thickness larger than or smaller than λ/4n, the resultant structure can transmit 808 nm and reflect 910 nm or 1064 nm. The resultant structure has an optical thickness of about 18.6 nm and a physical thickness in the order of 5445.8 nm.

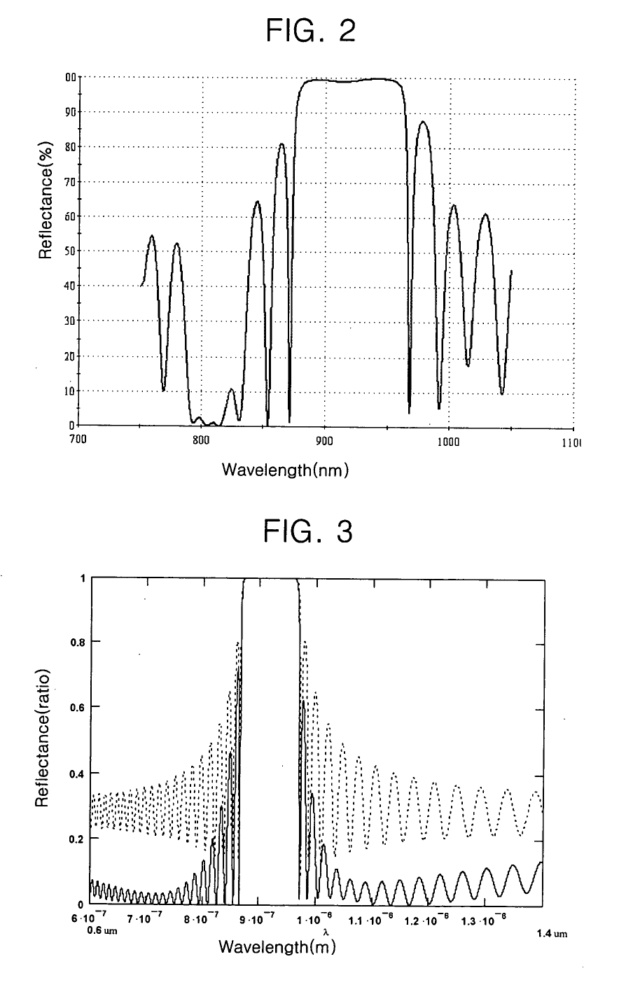

In this process, the optical thickness represents a wavelength unit in a material, therefore, when n is 1, λ/4n=¼, i.e., 0.25. When the DBR is formed as described above, the reflectance at 808 nm is approximately 0%, and reflectance at 910 nm is approximately 100%, as shown in FIG. 2.

In another exemplary embodiment, when two additional dielectric layers are formed at a lower part of the DBR, the source light R1 of 808 nm may have higher transmissivity, as shown in FIG. 3, but the reflectance at 808 nm is approximately “0”, and the reflectance in the range of 900 to 1070 nm is approximately “1”. That is, the transmissivity of the source light R1 is increased, while the reflectance at the basic wavelength R2 is also increased.

A first layer of the dielectric layers may be formed of silicon oxide (SiO₂), and a second layer of the dielectric layers may be formed of titanium oxide (TiO₂). The first and second layers may have different thickness. In an exemplary embodiment, the silicon oxide may be formed to a thickness in the order of 64.24 nm, and the titanium oxide to a thickness in the order of 75.48 nm.

Returning to FIG. 1, a second reflective layer or body 140 is deposited on gain medium 130. The second reflective body 140 may be formed of a multi-layered semiconductor thin layer, similar to the first reflective body 120 as described above, thereby transmitting and reflecting a desired wavelength by appropriately adjusting the thickness.

The second reflective body 140 transmits the basic wavelength R2 of 910 nm or 1064 nm generated from the quantum wells of the gain medium 130, and reflects the wavelength of the source light R1 of 808 nm back into the gain medium 130.

A heat sink 150 is formed on the second reflective body 140. The heat sink 150 may be formed of a transmissive material such as silicon carbide. The heat sink 150 functions to radiate heat generated from the gain medium to the exterior. Of course, the substrate 100 also functions as a heat radiator to dissipate heat generated in the quantum layers. In one aspect, the heat sink 150 may be formed of titanium carbide.

The substrate 100, the gain medium 130 and the heat sink 150 may be adhered by the well-known methanol capillarity method of adhering two substrates using a capillary phenomenon in a bath in which methanol is stored.

In another aspect, a filter 160 is deposited over the heat sink 150, and a nonlinear crystal 170 is deposited over the filter 160. Before describing the filter 160, the nonlinear crystal 170 will be first described.

The nonlinear crystal 170 functions to generate a second harmonic of the basic wavelength R2 to form a predetermined wavelength R3. The nonlinear crystal 170 generates a wavelength having a degree higher than the basic wavelength R2 due to non-linearity features of the crystal.

For example, when the basic wavelength R2 of 1064 nm enters crystal 170, a wavelength of 532 nm is generated. The wavelength of 532 nm represents a green light. Similarly, when the basic wavelength R2 of 910 nm enters crystal 170, a wavelength of 455 nm is generated. The wavelength of 455 nm represents a blue light. Thus, when the basic wavelength R2 enters nonlinear crystal 170, it is possible to obtain either a green or a blue light in accordance with an exemplary embodiment of the present invention.

The nonlinear crystal 170 may be formed of one of KTP (KTiOPO₄: potassium titanyl phosphate), LBO (LiB₃O₅: lithium tri-borate), PPLN (periodically poled lithium niobate), and PPMgOLN (periodically poled magnesium oxide-doped lithium niobate).

Meanwhile, the filter 160 may be a birefringence filter. The birefringence filter 160 functions to increase efficiency of second harmonic generation (SHG) by maintaining polarization of the basic wavelength R2 in a specific direction. In addition, since the birefringence filter 160 has several nanometers of transmissive spectrum bandwidth, the birefringence filter 160 simultaneously functions as a filter for filtering spectra out of the bandwidth. The predetermined wavelength R3 is generated from the nonlinear crystal 170 and is reflected to a surface by an HR mirror coating layer 171 formed at one surface of the nonlinear crystal 170.

An output mirror 180 is formed over the nonlinear crystal 170. The output mirror 180 focuses and transmits the second harmonic generated (R3) from the nonlinear crystal 170 to the exterior. A selective reflective part 190 is formed on a lower surface of the output mirror 180 to transmit the predetermined wavelength R3 and to reflect the basic wavelength R2. The selective reflective part 190 may be configured by applying a DBR similar to that previously described.

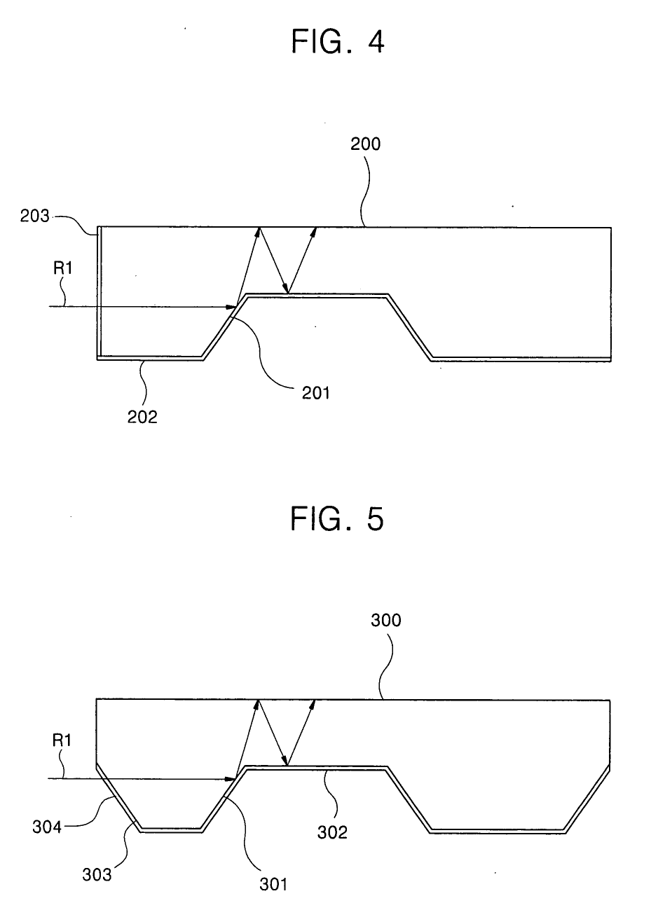

In another exemplary embodiment of the present invention, as shown in FIG. 4, a groove 201 may be additionally formed at a lower part of a substrate 200. The groove 201 may be formed to have an approximate “V”-shape. When the substrate 200 is formed of silicon carbide and a reflective surface 202 for reflecting a source light R1 is coated on a lower surface of the substrate 200, the source light R1 is resonated in the substrate 200 several times by the V-shaped groove to induce generation of a basic wavelength R2 having higher efficiency. The groove 201 also functions to easily package the optically pumped semiconductor laser. In addition, an AR (anti-reflective) coating layer 203 may be additionally deposited on a surface to which the source light R1 applied.

In still another exemplary embodiment of the present invention, as shown in FIG. 5, an inclined surface 303 is formed at a side surface of a substrate 300, and a reflective surface 302 is formed on a bottom surface of the substrate 300 so that a transmitted source light R1 can be reflected by the reflective surface 302. An AR coating layer 304 may be additionally formed on the inclined surface 303. The substrate may be variously modified to perform another side surface reflection and transmission.

Hereinafter, an optical pumping method of the optically pumped semiconductor laser in accordance with the present invention will be described.

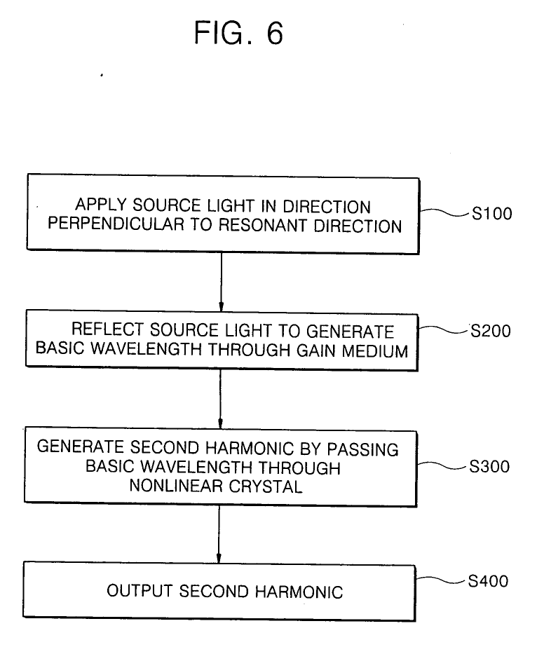

As shown in FIG. 6, at step S100, a source light R1 of 808 nm, for example, is generated by a light source 110 and applied to an inclined surface formed at a side surface of a substrate 100 in a direction substantially perpendicular to a direction that a green light of 532 nm or a blue light of 455 nm emerges from the device shown in FIG. 1.

When the source light R1 is applied, the source light R1 is transmitted toward a first reflective body 120 by a source light reflective part 102 formed at a guide surface 101. Therefore, electrons excited in the gain medium 130 formed of a semiconductor material and are transitioned in a plurality of quantum wells to generate a basic wavelength R2 of 1064 nm or 910 nm (S200). The generated basic wavelength R2 may be selectively generated by composition of the gain medium 130.

The basic wavelength R2 is reflected by the first reflective body 120 toward second reflective body 140. The second reflective body 140 transmits only the basic wavelength R2 and reflects the source light R1. In addition, the source light R1 continuously resonates in the gain medium 130 so that the basic wavelength R2 is continuously generated by the gain medium 130. Therefore, the space between the second reflective body 140 and the substrate 100 represents a first resonant region for the source light R1.

The basic wavelength R2 generated from the gain medium 130 transmits through the second reflective body 140, is applied to a birefringence filter 160 and subsequently is applied to a nonlinear crystal 170. The nonlinear crystal 170 generates a predetermined wavelength R3 as a second harmonic of the applied basic wavelength R2 (S300).

For example, when the basic wavelength R2 is 1064 nm, a green light of 532 nm is generated, and when the basic wavelength R2 is 910 nm, a blue light of 455 nm is generated. In addition, the predetermined wavelength R3 generated from the nonlinear crystal 170, is reflected by an HR (high-reflective) coating layer 171 formed at a lower surface of the nonlinear crystal 170.

The predetermined wavelength R3 generated from the nonlinear crystal 170 is directed to an output mirror 180. The output mirror 180 focuses the predetermined wavelength R3 as the output of laser (S400). As is also shown, the basic wavelength R2 passing through the nonlinear crystal 170 is reflected by a selective reflective body 190 formed at a lower surface of the output mirror 180. Therefore, the basic wavelength R2 resonates between the first reflective body 120 and the output mirror 180. Thus, the space between the output mirror 180 and the first reflective body 120 is a resonant region of the basic wavelength R2.

Meanwhile, when the light is reflected and transmitted through each region by resonance of the wavelength, a great deal of heat is generated. However, the generated heat is dissipated to the exterior through a heat sink 150 installed between the birefringence filter 160 and the second reflective body 140. In addition, the substrate 100 also functions as a heat radiator to dissipate the heat generated.

As can be seen from the foregoing, the optically pumped semiconductor laser in accordance with the present invention can perform side pumping to facilitate packaging of the optically pumped semiconductor laser and to miniaturize the laser, thereby obtaining high efficiency due to multi-beam absorption, and good thermal characteristics.

While this invention has been described in connection with what is presently considered to be the most practical and exemplary embodiment, it is to be understood that the invention is not limited to the disclosed embodiment, but on the contrary, it is intended to cover various modification within the spirit and the scope of the Invention, which is set forth in the appended claims.

What is claimed is:

1. An optically pumped semiconductor laser comprising:
first and second reflective layers forming a resonant region therebetween;
a gain medium deposited between the first and second reflective layers; and
a light source for applying a source light to the resonant region in a lateral direction with regard to the gain medium for generating a basic wavelength.

2. The optically pumped semiconductor laser according to claim 1, wherein the gain medium comprises a plurality of quantum wells.

3. The optically pumped semiconductor laser according to claim 1, further comprising:
an output mirror for emitting a predetermined wavelength as a second harmonic of the basic wavelength generated by a nonlinear crystal disposed between the output mirror and the second reflective body.

4. The optically pumped semiconductor laser according to claim 3, further comprising:
a selective reflective part disposed at a surface of the output mirror opposite to the nonlinear crystal to transmit the predetermined wavelength and to reflect the basic wavelength.

5. The optically pumped semiconductor laser according to claim 4, further comprising:
a filter disposed between the second reflective body and the nonlinear crystal to reflect the predetermined wavelength and to transmit the basic wavelength to the gain medium.

6. The optically pumped semiconductor laser according to claim 5, further comprising:
a heat sink disposed between the filter and the first reflective body.

7. The optically pumped semiconductor laser according to claim 6, wherein the heat sink is material selected from the group consisting of: silicon carbide (SiC) and titatium carbide (TiC).

8. The optically pumped semiconductor laser according to claim 6, wherein the source light has a wavelength of 808 nm.

9. The optically pumped semiconductor laser according to claim 8, wherein the basic wavelength is selected from the group consisting of: 910 nm and 1064 nm.

10. The optically pumped semiconductor laser according to claim 9, wherein the predetermined wavelength is selected from the group consisting of: 455 nm and 532 nm.

11. The optically pumped semiconductor laser according to claim 1, further comprising:
a substrate installed at a surface of the first reflective body opposite to a surface of the first reflective body in contact with the gain medium, wherein the source light is applied to the substrate in a lateral direction.

12. The optically pumped semiconductor laser according to claim 11, wherein the first reflective body is formed of a multi-layered semiconductor material, and has at least one dielectric layer formed at a surface opposite to the substrate.

13. The optically pumped semiconductor laser according to claim 11, wherein the surface of the substrate to which the source light is applied is formed inclined to guide the source light to the gain medium.

14. The optically pumped semiconductor laser according to claim 11, wherein the substrate is a material selected from the group consisting of: silicon carbide (SiC), aluminum nitride (AlN), and gallium arsenide (GaAs).

15. The optically pumped semiconductor laser according to claim 13, wherein the inclined surface of the substrate has a source light reflective part for reflecting the source light to the gain medium.

16. The optically pumped semiconductor laser according to claim 13, further comprising:
a groove formed on a surface of the substrate opposite to a surface of the substrate in contact with the gain medium.

17. An optically pumped semiconductor laser comprising:
a substrate;
an output mirror installed spaced apart from the substrate to form a resonant region between the substrate and the output mirror;
a light source for applying a source light to the substrate in a direction lateral to the substrate;
a guide part for guiding the source light scanned to the substrate toward the output mirror;
a gain medium disposed between the substrate and the output mirror to generate a basic wavelength using the source light guided by the guide part;
a nonlinear crystal disposed between the gain medium and the output mirror to generate a predetermined wavelength of second harmonic of the basic wavelength;
a filter disposed between the nonlinear crystal and the gain medium to transmit the basic wavelength generated from the gain medium and to maintain the basic wavelength in a specific polarization;
a first reflective body disposed between the gain medium and the substrate to transmit the source light to the gain medium and to reflect the basic wavelength;
a second reflective body disposed between the filter and the gain medium to reflect the source light to the gain medium and to transmit the basic wavelength to the filter; and
a selective reflective part disposed at a surface of the output mirror opposite to the nonlinear crystal to transmit the predetermined wavelength and to reflect the basic wavelength.

18. The optically pumped semiconductor laser according to claim 17, wherein the guide part comprises an inclined surface formed at a surface of the substrate to which the source light is applied, and a reflective part for reflecting the source light to the gain medium.

19. The optically pumped semiconductor laser according to claim 17, wherein the gain medium is formed of a plurality of quantum wells.

20. The optically pumped semiconductor laser according to claim 17, wherein the first reflective body comprises at least one semiconductor material, and at least one dielectric layer formed at a surface of the first relfective body opposite to the substrate.

21. The optically pumped semiconductor laser according to claim 17, wherein the source light has a wavelength of 808 nm.

22. The optically pumped semiconductor laser according to claim 21, wherein the basic wavelength is selected from the group consisting of: 910 nm and 1064 nm.

23. The optically pumped semiconductor laser according to claim 21, wherein the predetermined wavelength is selected from the group consisting of: 455 nm and 532 nm.

24. The optically pumped semiconductor laser according to claim 17, further comprising:
a heat sink disposed between the filter and the second reflective body.

25. The optically pumped semiconductor laser according to claim 24, wherein the heat sink is selected from the group consisting of: silicon carbide (SiC) and titatium carbide (TiC).

26. The optically pumped semiconductor laser according to claim 17, wherein the substrate is selected from the group consisting of: silicon carbide (SiC), aluminum nitride (AlN), and gallium arsenide (GaAs).

27. The optically pumped semiconductor laser according to claim 17, further comprising:
a groove formed on a surface of the substrate opposite to a surface of the substrate in contact with the gain medium.

28. An optical pumping method comprising:
applying a source light in a direction substantially perpendicular to a resonant direction;
reflecting the source light to a gain medium to generate a basic wavelength through the gain medium;
generating a predetermined wavelength as a second harmonic of the basic wavelength generated from the gain medium through a nonlinear crystal; and
outputting the predetermined wavelength.

29. The method according to claim 28, wherein the source light is applied in a direction approximately perpendicular to an output direction of the predetermined wavelenth.

30. The method according to claim 28, wherein the source light is applied to a substrate disposed at one side of the gain medium, and the substrate has a groove to be packaged.

31. The method according to claim 28, wherein the gain medium is formed of a plurality of quantum wells.

32. The method according to claim 28, wherein the source light has a wavelength of 808 nm.

33. The method according to claim 32, wherein the basic wavelength is selected from the group consisting of: 910 nm and 1064 nm.

34. The method according to claim 33, wherein the second harmonic is selected from the group consisting of: 455 nm and 532 nm.
